(19) United States
(12) Patent Application Publication
(10) Pub. No.: US 2013/0215329 A1
(43) Pub. Date: Aug. 22, 2013

(54) IMAGE PROCESSING APPARATUS AND IMAGE DISPLAYING SYSTEM

(71) Applicant: Milosz Gabriel Sroka Chalot, Yokohama-Shi (JP)

(72) Inventor: Milosz Gabriel Sroka Chalot, Yokohama-Shi (JP)

(73) Assignee: KABUSHIKI KAISHA TOSHIBA, Tokyo (JP)

(21) Appl. No.: 13/597,696

(22) Filed: Aug. 29, 2012

(30) Foreign Application Priority Data
Feb. 22, 2012 (JP) 2012-036386

(51) Int. Cl. H04N 5/445

(52) U.S. Cl. 348/564; 348/E05.099

(57) ABSTRACT

According to one embodiment, an image processing apparatus includes a display area selector and a display manager. The display area selector selects a display area in a frame of video image data based on motion of a video image in the frame and a size of an application image displayed in the display area. The display manager combines the video image data with the application image data to generate display image data in such a manner that the application image is displayed in the display image area.

### CROSS REFERENCE TO RELATED APPLICATION(S)

This application is based upon and claims the benefit of priority from the prior Japanese Patent Application No. 2012-036386, filed on Feb. 22, 2012, the entire contents of which are incorporated herein by reference.

### FIELD

Embodiments described herein relate generally to an image processing apparatus and an image displaying system.

### BACKGROUND

Recently there is a demand, in which an application is installed in a television and an application image of the installed application is displayed while superimposed on an image displayed on the television. In such cases, a module that selects a display area in which the application image should be displayed is required in a display.

In a conventional image display, when another image is displayed while superimposed on a background image, an area with fewer motions in the background image is selected as a display area, and another image is displayed in the display area while superimposed on the background image. However, in the conventional image display, even if an important image such as a person exists in the area with fewer motions, the area with fewer motions, in which the important image is included, is selected as the display area. As a result, another image is displayed superimposed on the important image. Accordingly, in a case where the background image and the application image are simultaneously displayed, a user cannot view the important image in the background image.

### BRIEF DESCRIPTION OF THE DRAWINGS

FIG. 1 is a block diagram of the image display system 1 of the embodiment.

FIG. 2 is a schematic diagram of the display image of the embodiment.

FIG. 3 is a block diagram of the image decoder 12 of the embodiment.

FIG. 4 is a schematic diagram illustrating an example of a decoded frame of the embodiment.

FIG. 5 is a block diagram of the display area selector 16 of the embodiment.

FIG. 6 is a flowchart of the image processing of the embodiment.

FIG. 7 is a flowchart of the operation of the embodiment to select the display area.

FIG. 8 is a flowchart of the operation of the embodiment to detect the inactive area.

FIG. 9 is a flowchart of calculating the vector activity of the embodiment.

FIGS. 10A and 108 are an explanatory view of a vector activity calculating method.

FIG. 11 is a schematic diagram of an example of the vector activity obtained by calculating the vector activity of the embodiment.

FIG. 12 is a flowchart of calculating the coefficient activity of the embodiment.

FIG. 13 is an explanatory view of a coefficient activity calculating rule of the embodiment.

FIG. 14 is a schematic diagram of the coefficient activity obtained by calculating the coefficient activity of the embodiment.

FIG. 15 is a schematic diagram of the zone activity information obtained by calculating the zone activity of the embodiment.

FIG. 16 is a flowchart of the operation of the embodiment to determine the display area.

FIGS. 17 to 19 are explanatory views of the operation of the embodiment to determine the display area.

FIG. 20 is explanatory views of the operation of the modification of the embodiment to determine the display area.

### DETAILED DESCRIPTION

Embodiments will now be explained with reference to the accompanying drawings.

In general, according to one embodiment, an image processing apparatus includes a display area selector and a display manager. The display area selector selects a display area in a frame of video image data based on motion of a video image in the frame and a size of an application image displayed in the display area. The display manager combines the video image data with the application image data to generate display image data in such a manner that the application image is displayed in the display image area.

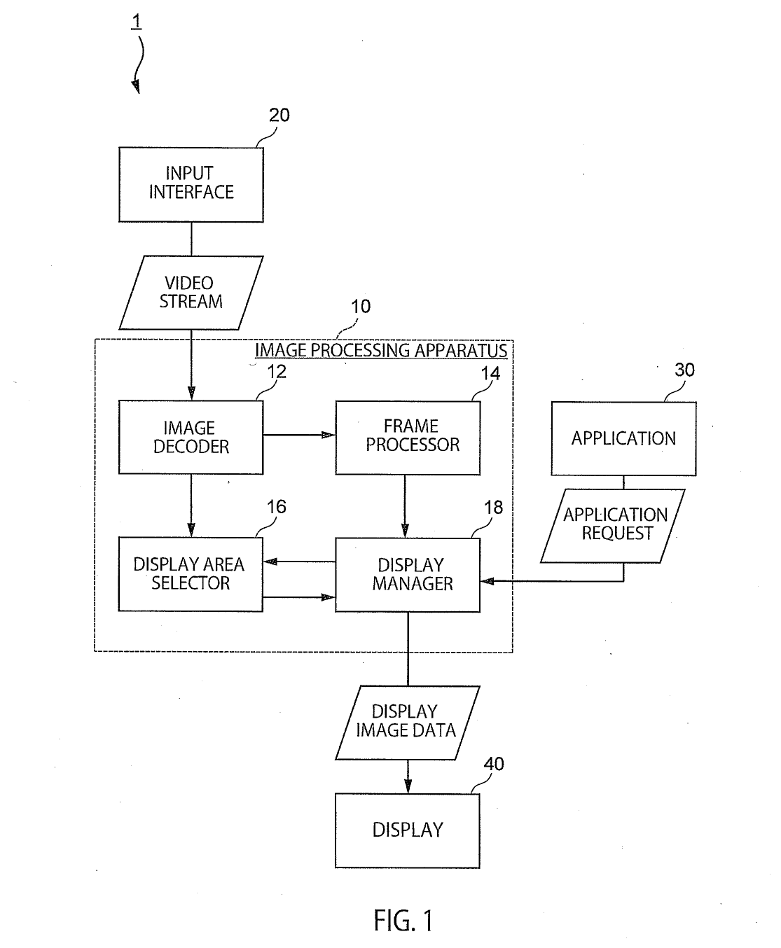

An image display system 1 according to an embodiment will be described below. FIG. 1 is a block diagram of the image display system 1 of the embodiment. The image display system 1 includes an image processing apparatus 10, an input interface 20, an application 30, and a display 40.

The input interface 20 inputs a video stream from an outside of the image display system 1. For example, the video stream is generated by a tuner that receives a data stream of digital television broadcasting or by a video encoder that generates coded data of video data.

The application 30 generates an application request to display the application image on the display 40. The application request includes application image data denoting the application image and size information indicating a display size of the application image. For example, the application image is an application widget or an advertisement.

The image processing apparatus 10 generates display image data based on the video stream and the application request. The display image data denotes a display image to be displayed on the display 40, and the display image data includes a video layer and an application layer. A video frame (that is, the video image data) is disposed in the video layer. The application image data is disposed in the application layer.

The image processing apparatus 10 includes an image decoder 12, a frame processor 14, a display area selector 16, and a display manager 18. The image decoder 12 decodes the video stream to generate a decoded frame. The frame processor 14 performs frame processing to the decoded frame to generate a video frame. The display manager 18 extracts the size information on the application image data from the input application request, and outputs the size information to the display area selector 16. The display area selector 16 selects a display area of the application image data based on a motion vector, the number of DCT (discrete cosine transformation) coefficients, and the size information. The display area denotes the area in which the application image data should be disposed in the application layer. The display manager 18 disposes the video frame in the video layer, disposes the application image data in the display area in the application layer, and combines the video layer and the application layer to generate the display image data.

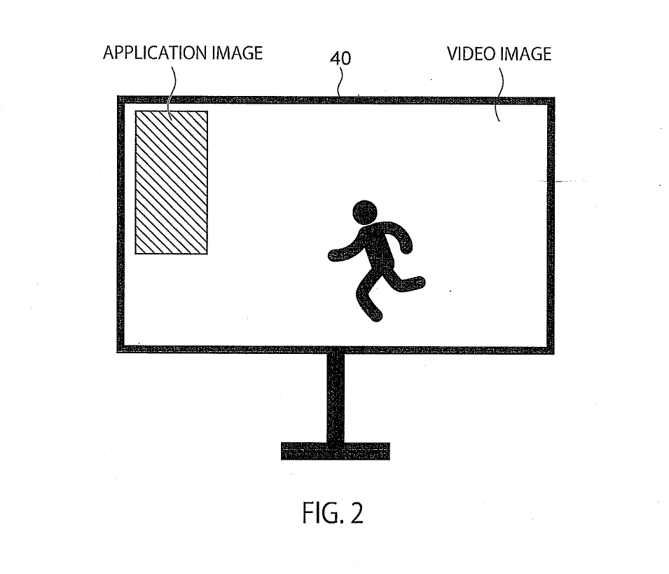

The display 40 displays the display image denoted by the display image data. For example, the display 40 is constructed by a liquid crystal panel or an organic EL (Electroluminescence Display) panel. Therefore, a user can simultaneously view the video image corresponding to the video frame and the application image. FIG. 2 is a schematic diagram of the display image of the embodiment.

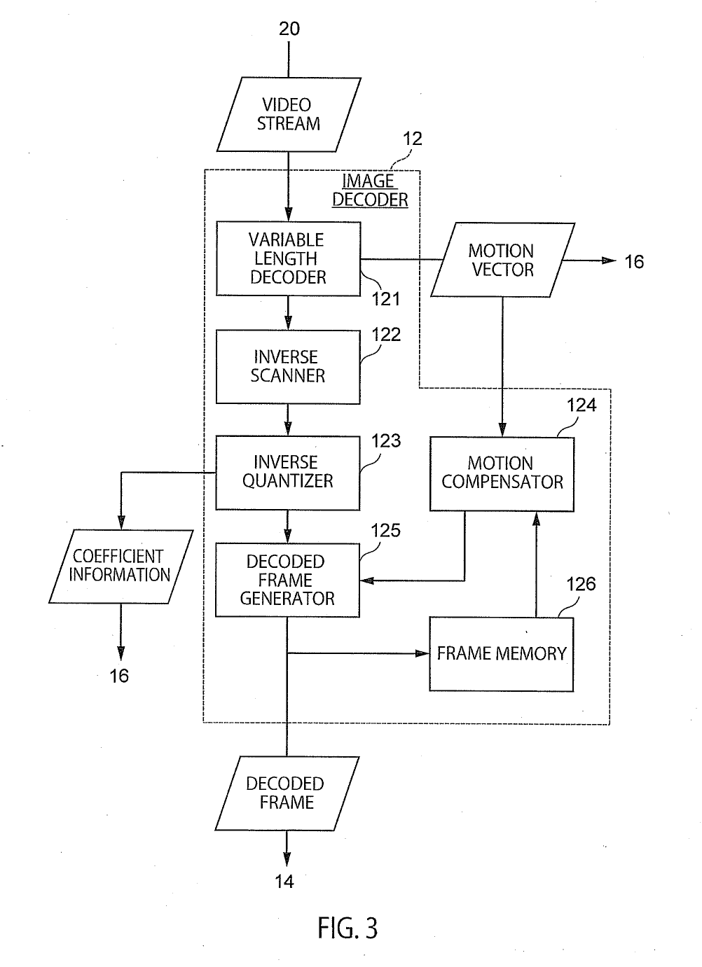

The image decoder 12 of the embodiment will be described below. FIG. 3 is a block diagram of the image decoder 12 of the embodiment. The image decoder 12 includes a variable length decoder 121, an inverse scanner 122, an inverse quantizer 123, a motion compensator 124, a decoded frame generator 125, and a frame memory 126.

The variable length decoder 121 performs variable length decoding processing to an nth (n is a natural number) video stream VF(n) to generate variable length decoded data VD(n) and a motion vector MV(n). The variable length decoded data VD(n) includes a signal (for example, a YUV signal indicating luminance and a color difference) denoting a pixel value of the video stream VF(n). The motion vector MV(n) indicates an amount and a direction of motion of the image of the video stream VF(n).

The inverse scanner 122 performs inverse scan processing on the variable length decoded data VD(n) to generate a quantized data Q(n). For example, the inverse scan processing is a zigzag scan or an alternate scan.

The inverse quantizer 123 performs inverse quantization processing on the quantized data (n) to generate DCT coefficient data DC(n). The inverse quantizer 123 counts the number of DCT coefficients to generate coefficient information CI(n). The coefficient information CI(n) indicates the number of DCT coefficients of the video stream VF(n). The motion vector MV(n) and the coefficient information CI(n) are outputted to the display area selector 16.

The motion compensator 124 generates a predicted image data PI(n) based on a decoded frame DF(n−1) (that is, a decoded frame corresponding to a video stream VF(n−1)) stored in the frame memory 126 and the motion vector MV(n).

The decoded frame generator 125 adds the predicted image data PI(n) to the DCT coefficient data DC(n) to generate a decoded frame DF(n). The decoded frame DF(n) is outputted to the frame processor 14. The decoded frame DF(n) is stored in the frame memory 126 and used to generate a decoded frame DF(n+1) (that is, a decoded frame corresponding to a video frame VF(n+1)).

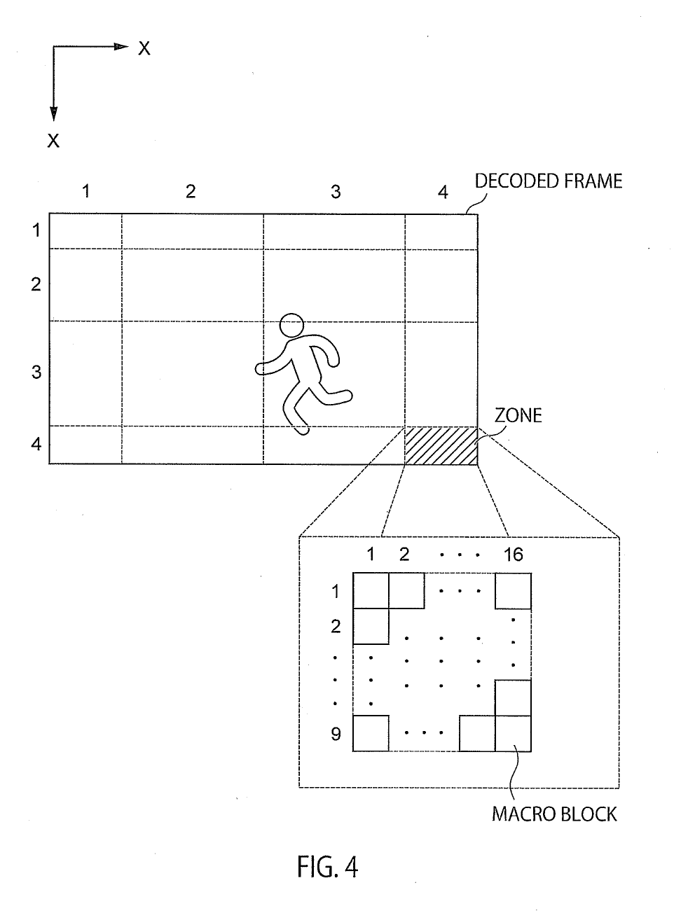

The decoded frame of the embodiment will be described. FIG. 4 is a schematic diagram illustrating an example of a decoded frame of the embodiment. The decoded frame includes a predetermined number (for example, 4×4) of zones. One zone includes plural (for example, 16×9) macro blocks. Desirably, the number of macro blocks is increased from the zone in an end portion of the decoded frame toward the central zone thereof (that is, the number of macro blocks varies in each zone). In a case where the variable length decoded data includes the YUV signal, the macro block includes at least one motion vector and a maximum of 384 (=8×8×6) DCT coefficients.

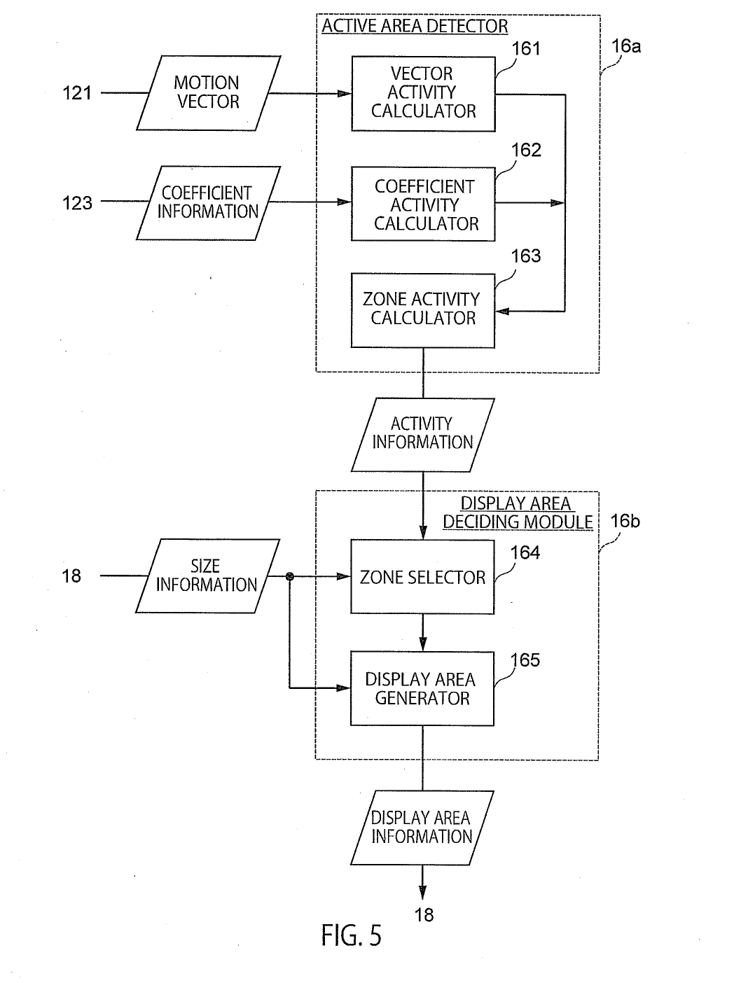

The display area selector 16 of the embodiment will be described below. FIG. 5 is a block diagram of the display area selector 16 of the embodiment. The display area selector 16 includes an active area detector 16a and a display area deciding module 16b. The active area detector 16a includes a vector activity calculator 161, a coefficient activity calculator 162, and a zone activity calculator 163. The display area deciding module 16b includes a zone selector 164 and a display area generator 165.

The vector activity calculator 161 calculates a vector activity based on the motion vector. The vector activity indicates a degree of importance of the image, which depends on the motion of the video image. The larger the vector activity is, the larger the degree of the importance of the image is.

The coefficient activity calculator 162 calculates a coefficient activity based on the coefficient information. The coefficient activity indicates a degree of importance of the image, which depends on a focus of the video image. The larger the coefficient activity is, the larger the degree of the importance of the image is.

The zone activity calculator 163 calculates a zone activity based on the vector activity and the coefficient activity. The zone activity indicates a degree of importance of the image, which depends on both the motion and the focus of the video image. The larger the zone activity is, the larger the degree of the importance of the image is. The zone activity calculator 163 also outputs the vector activity, the coefficient activity, and the zone activity as activity information.

The zone selector 164 selects an optimum display package (the application layer) for the display area of the application image based on the activity information and the size information. One display package includes one or plural zones. The number of zones included in one display package depends on the size information. The display area generator 165 generates display area information based on the display package. The display area information indicates the display area of the application image. For example, the display area has a rectangular shape defined by two coordinates, a circular shape, an elliptical shape, a polygonal shape, plural curved lines, or an arbitrary shape formed by a combination thereof.

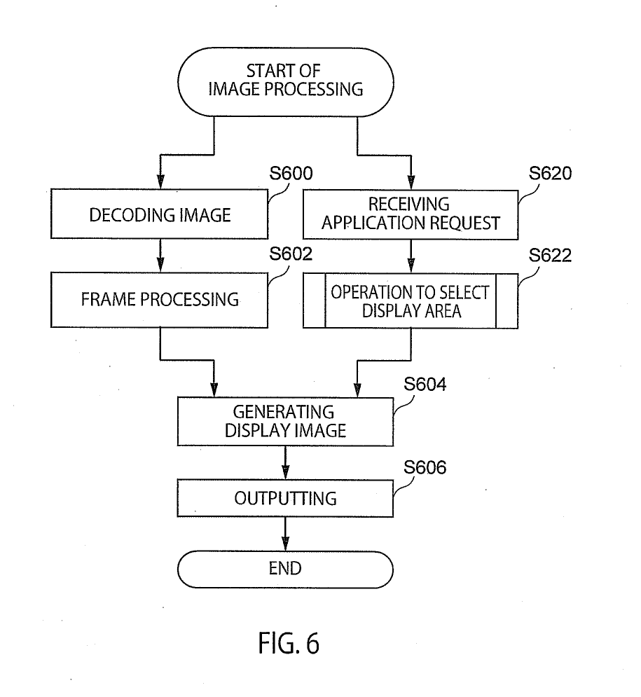

An operation of image processing apparatus 10 of the embodiment will be described. FIG. 6 is a flowchart of the image processing of the embodiment. In the image processing, decoding the image (S600) and frame processing (S602), and receiving the request (S620) and an operation to select the display area (S622) are performed in parallel. After S602 and S622 end, generating display image (S604) and outputting (S606) are performed.

<S600 and S602> The image decoder 12 decodes the video stream to generates the decoded frame (S600). The frame processor 14 performs the frame processing on the decoded frame to generate the video frame (S602).

<S620 and S622> The display manager 18 receives an application request from the application 30 (S620). The display area selector 16 selects the display area, where the application image data included in the application request is displayed, based on the motion vector, the coefficient information, and the size information (S622).

<S604 and S606> The display manager 18 combines the video layer and the application layer to generate the display image data in which the application image data is disposed in the desired display area (S604). The display manager 18 outputs the display image data to the display 40 (S606).

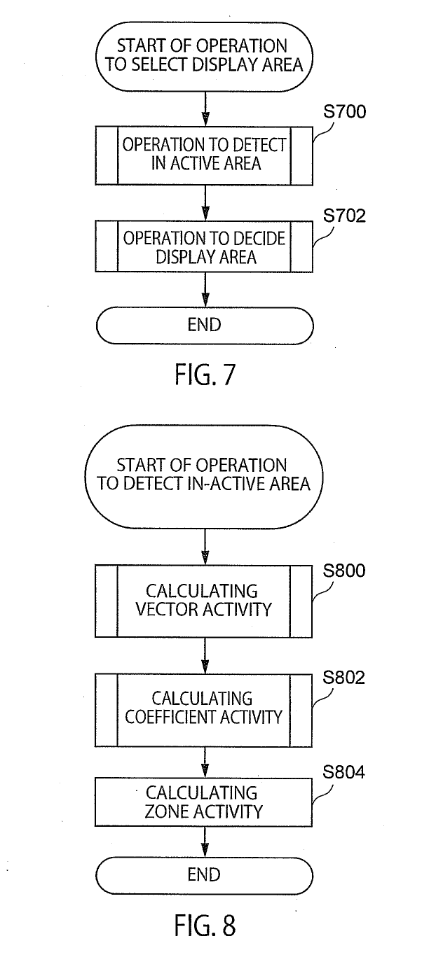

FIG. 7 is a flowchart of the operation of the embodiment to select the display area. In the operation to select the display area, an operation to detect an inactive area (S700) and an operation to determine the display area (S702) are performed. The display area selector 16 detects the inactive area (S700). The inactive area is the area in which the motion and the focus of the video image are fewer than those of average values of the whole frame. The display area selector 16 determines at least a part of the inactive area as the display area (S702). After S702 ends, the flow proceeds to S604.

FIG. 8 is a flowchart of the operation of the embodiment to detect the inactive area. In the operation to detect the inactive area, calculating the vector activity (S800), calculating the coefficient activity (S802), and calculating the zone activity (S804) are performed. S800 and S802 can be performed in random order. After S804 ends, the flow proceeds to S702.

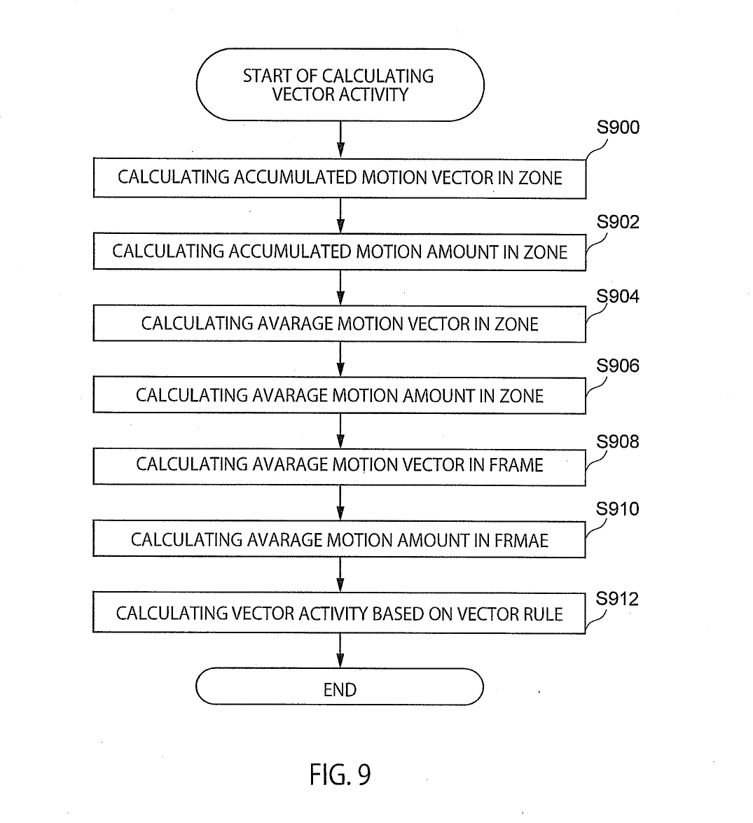

FIG. 9 is a flowchart of calculating the vector activity of the embodiment. The vector activity calculator 161 calculates an accumulated motion vector in each zone (S900). The accumulated motion vector in the zone means a sum of the motion vectors of all the macro blocks in one zone.

The vector activity calculator 161 calculates an accumulated motion amount in each zone (S902). The accumulated motion amount in the zone means a sum of absolute values of the motion vectors of all the macro blocks in one zone.

The vector activity calculator 161 calculates an average motion vector in each zone (S904). The average motion vector in the zone means a quotient of the accumulated motion vector in one zone and the number of macro blocks in one zone.

The vector activity calculator 161 calculates an average motion amount in each zone (S906). The average motion amount in the zone means a quotient of the accumulated motion amount in one zone and the number of macro blocks in one zone.

The vector activity calculator 161 calculates an average motion vector in the frame (S908). The average motion vector in the frame means a quotient of the accumulated motion vectors in all the zones and the number of macro blocks in all the zones.

The vector activity calculator 161 calculates an average motion amount in the frame (S910). The average motion amount in the frame means a quotient of the accumulated motion amounts in all the zones and the number of macro blocks in all the zones.

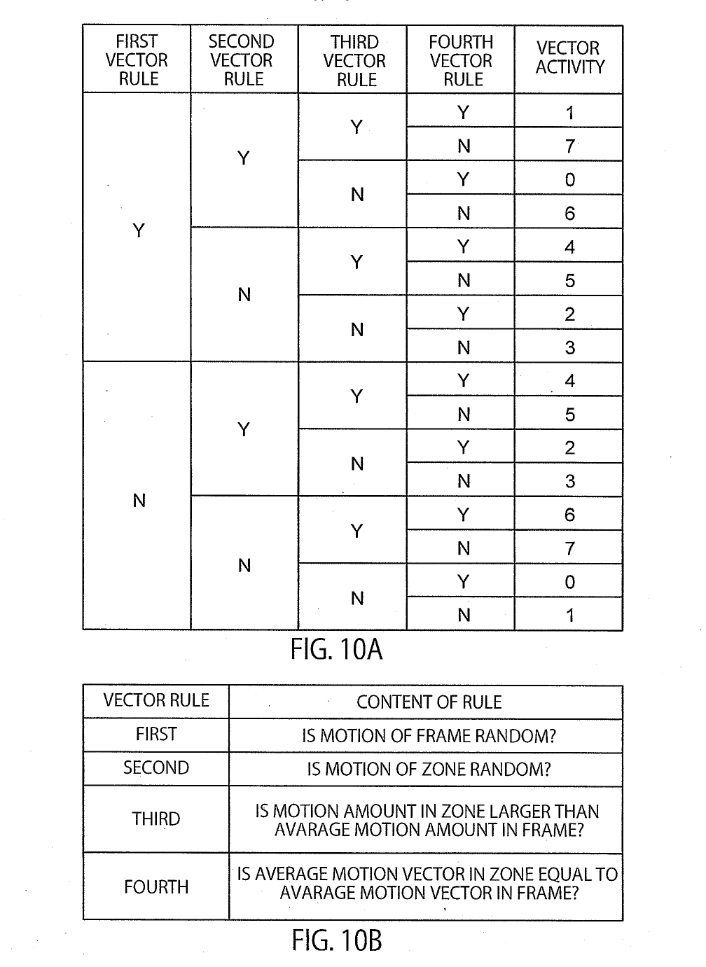

The vector activity calculator 161 calculates the vector activity based on a vector rule (S912). FIGS. 10A and 10B are an explanatory view of a vector activity calculating method. As illustrated in FIG. 10A, the vector rule is the rule that determines vector activities 0 to 7, and the vector rule includes first to fourth vector rules. “Y” indicates that the vector activity matched the vector rule, and “N” indicates that the vector activity does not match the vector rule.

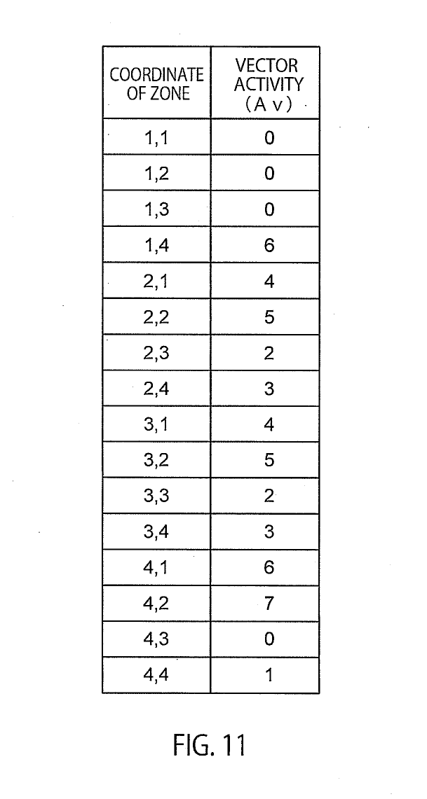

As illustrated in FIG. 10B, the first vector rule is “whether the motion in the frame is random”, the second vector rule is “whether the motion in the zone is random”, the third vector rule is “whether the motion amount in the zone is larger than the average motion amount in the frame”, and the fourth vector rule is “whether the average motion vector in the zone is equal to the average motion vector in the frame”. “The average motion vector in the zone is equal to the average motion vector in the frame” means that the motion in the zone is equal to the motion in the frame. For example, it is assumed that the motions in the frame and the zone are random (that is, the vector activity matches the first and second vector rules), it is assumed that the motion amount in the zone is larger than the average motion amount in the frame (that is, the vector activity matches the third vector rule), and it is assumed that the average motion vector in the zone is larger than the average motion vector in the frame (that is, the vector activity does not match fourth vector rule). In this case, the vector activity is “1”. The vector activity in each zone is obtained by applying the vector rule in each zone. FIG. 11 is a schematic diagram of an example of the vector activity obtained by calculating the vector activity of the embodiment. After S912 ends, the flow proceeds to S802.

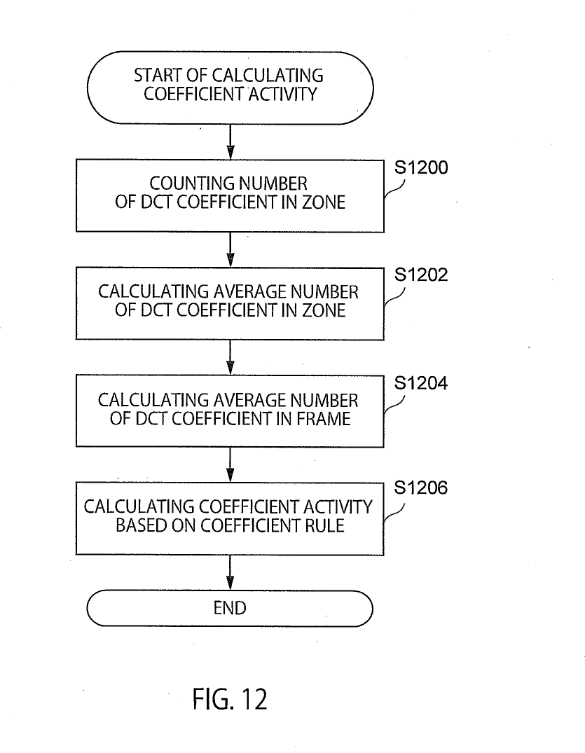

FIG. 12 is a flowchart of calculating the coefficient activity of the embodiment. The coefficient activity calculator 162 counts the number of DCT coefficients in each zone (S1200). The number of DCT coefficients in the zone means the total number of DCT coefficients of all the macro blocks in one zone.

The coefficient activity calculator 162 calculates an average value of the numbers of DCT coefficients with respect to each zone (S1202). The average value of the numbers of DCT coefficients means a quotient of the number of DCT coefficients in one zone and the number of macro blocks in one zone.

The coefficient activity calculator 162 calculates an average value of the numbers of DCT coefficients in the frame (S1204). The average value of the numbers of DCT coefficients means a quotient of the total number of DCT coefficients in all the zones and the number of macro blocks in all the zones.

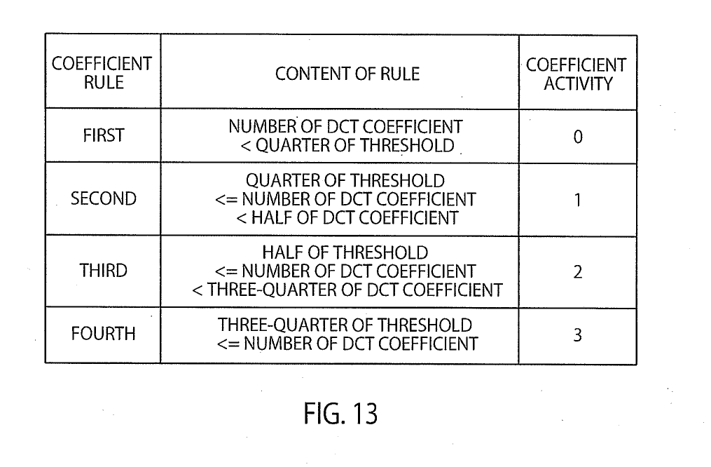

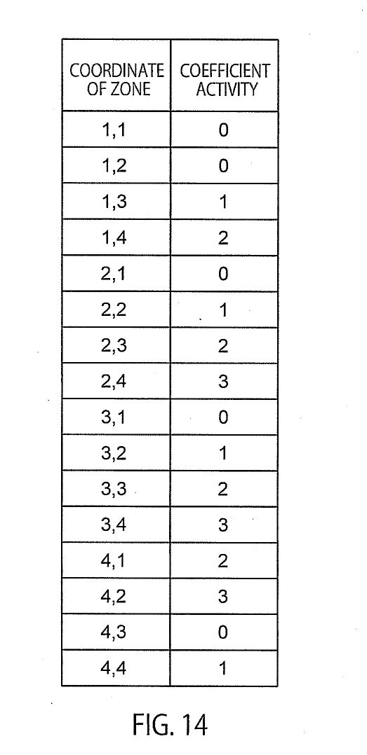

The coefficient activity calculator 162 calculates the coefficient activity based on a coefficient rule (S1206). The coefficient rule is the rule that determines coefficient activities 0 to 3. FIG. 13 is an explanatory view of a coefficient activity calculating rule of the embodiment. As illustrated in FIG. 13, for example, the coefficient activity calculating rule includes first to fourth coefficient rules. The first coefficient rule is “the number of DCT coefficients<quarter of threshold”, the second coefficient rule is “quarter of threshold<=the number of DCT coefficients<half of threshold”, the third coefficient rule is “half of threshold<=the number of DCT coefficients<three quarters of threshold”, and the fourth coefficient rule is “three quarters of threshold<=the number of DCT coefficients”. For example, in a case where a degree of the focus in the zone is relatively small (that is, the coefficient activity matches the first coefficient rule), the coefficient activity is “1”. The coefficient activity in each zone is obtained by applying the coefficient rule in each zone. FIG. 14 is a schematic diagram of the coefficient activity obtained by calculating the coefficient activity of the embodiment. After S1206 ends, the flow proceeds to S804.

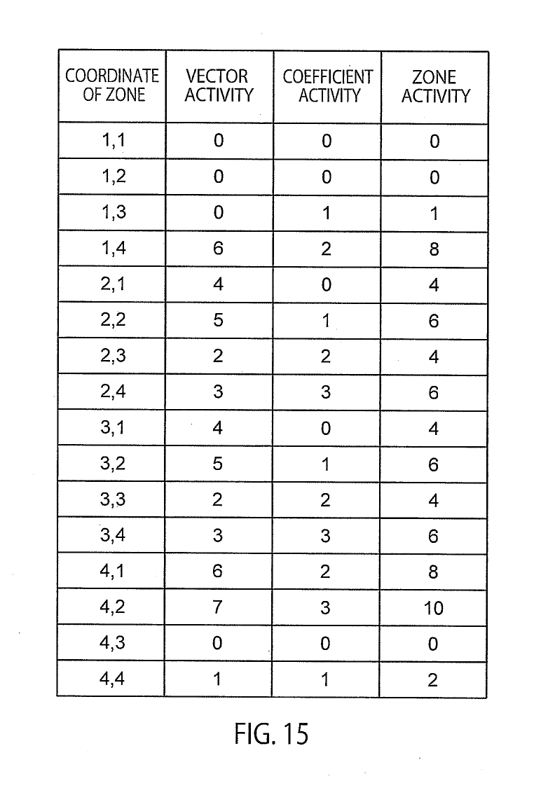

The zone activity calculator 163 calculates the zone activity based on the vector activity and the coefficient activity (S804). The zone activity is the sum of the vector activity and the coefficient activity. Thus, activity information indicating the vector activity, the coefficient activity, and the zone activity for each zone can be obtained. FIG. 15 is a schematic diagram of the zone activity information obtained by calculating the zone activity of the embodiment. After S804 ends, the flow proceeds to S702.

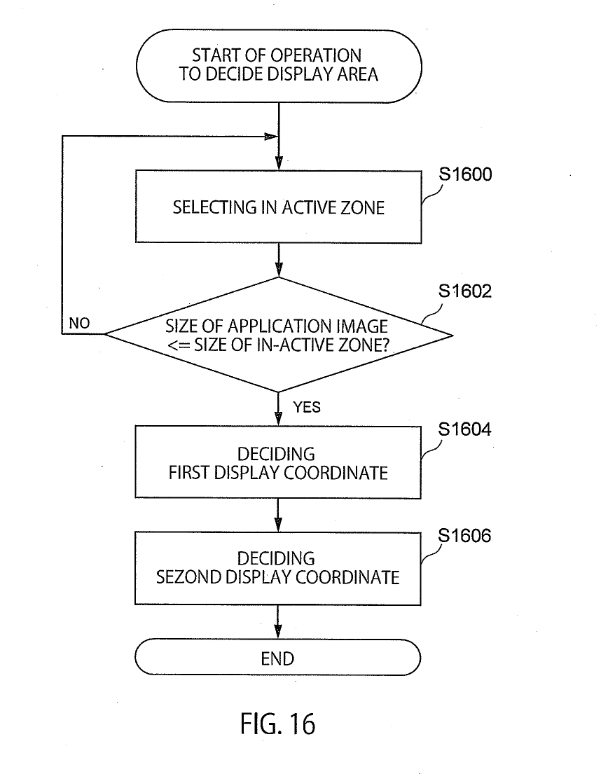

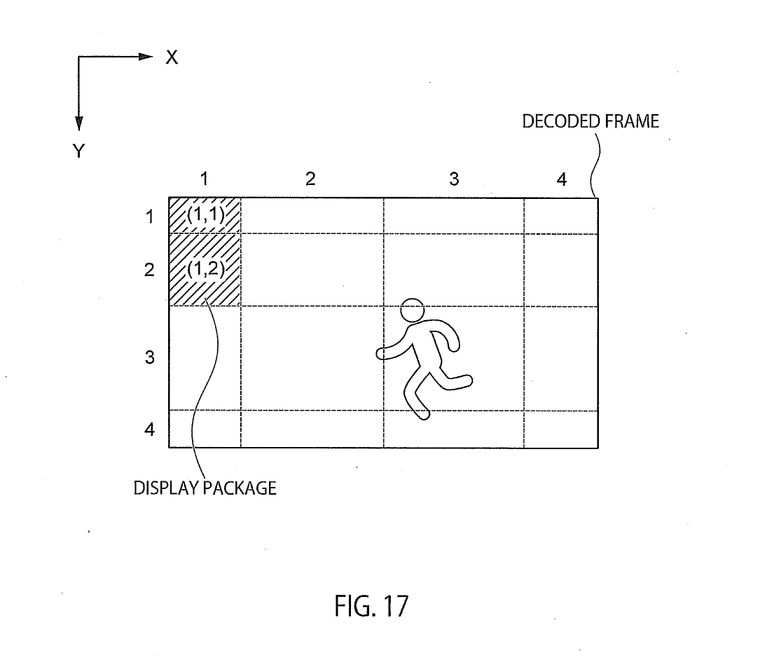

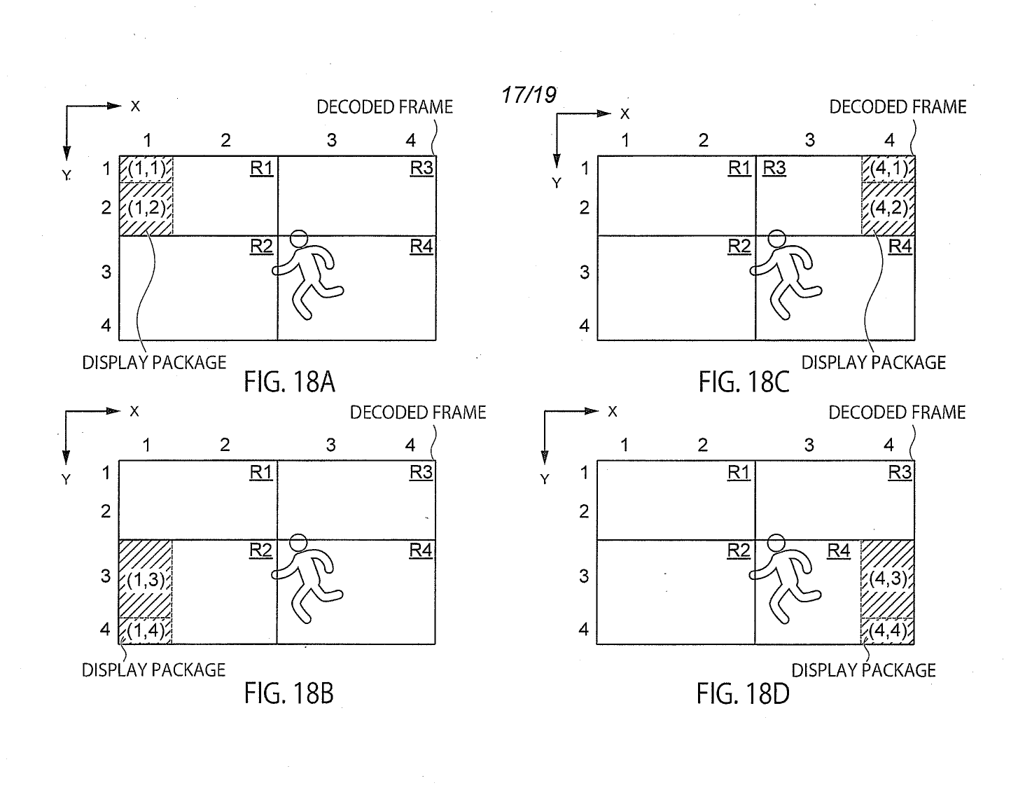

FIG. 16 is a flowchart of the operation of the embodiment to determine the display area. FIGS. 17 to 19 are explanatory views of the operation of the embodiment to determine the display area

<S1600> The zone selector 164 selects an inactive zone. The inactive zone is the zone in which the zone activity is minimal. In a case of FIG. 15, a zone (1,1), (1,2), or (4,3) in which the zone activity is “0” is selected as the inactive zone.

<S1602> The zone selector 164 determines whether the size of the application image is equal to or smaller than the size of the inactive zone based on the size information. When the size of the application image is equal to or smaller than the size of the selected inactive zone (YES in S1602), the flow proceeds to S1604. When the size of the application image is larger than the size of the selected inactive zone (NO in S1602), the zone selector 164 selects an additional inactive zone (S1600). The additional inactive zone is the zone in which the zone activity is minimal in the zones adjacent to the initially-selected inactive zone. In cases of FIGS. 4 and 15, when the zone (1,1) is selected as the initial inactive zone, then the zone (1,2) is selected as the additional zone activity. A set of inactive zones having the size equal to or larger than the size of the application image is the display package (see FIG. 17).

<S1604> The display area generator 165 determines any one of four coordinates of the display package as a first display coordinate P1. Specifically, the display area generator 165 divides the decoded frame into first to fourth areas R1 to R4 (see FIGS. 18A to 18D). Each of the first to fourth areas R1 to R4 is constructed by plural zones including zones (1,1), (1,4), (4,1), and (4,4) that are of vertices of the decoded frame. Then the display area generator 165 determines a first display coordinate P1(xp1,yp1) according to the area (any one of the first to fourth areas R1 to R4) to which the display package belongs.

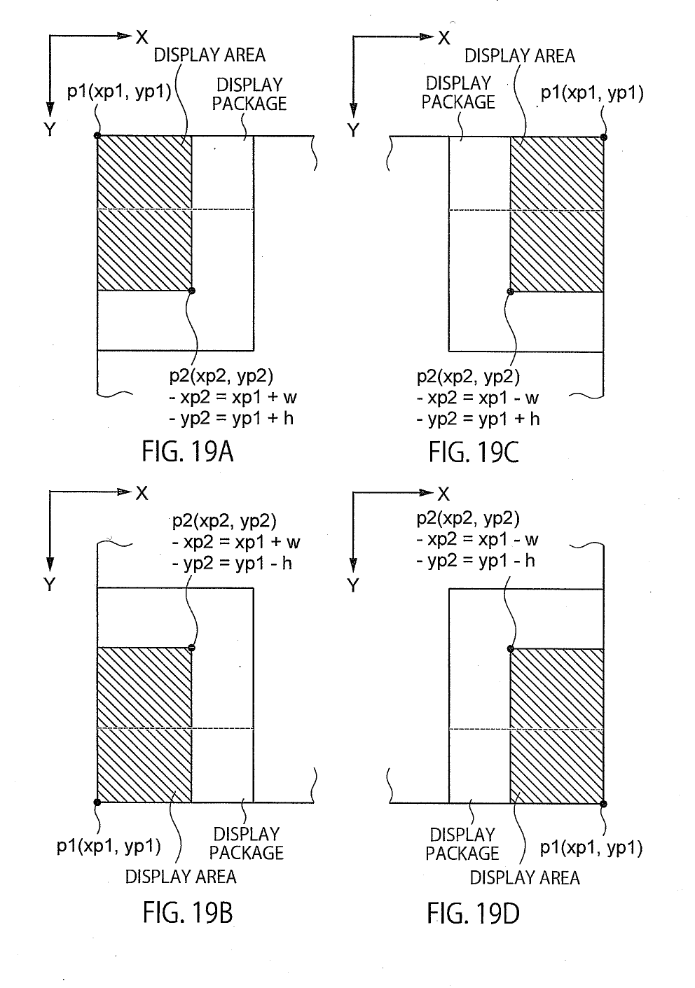

For example, in a case of FIG. 18A (that is, the case where the display package belongs to the first area R1), the display area generator 165 determines a minimum X-coordinate (xmin) and a minimum Y-coordinate (ymin) of the display package as the first display coordinate P1(xp1,yp1) (see FIG. 19A). In this case, the first display coordinate P1 is the coordinate in which values of an X-coordinate and a Y-coordinate on a decoded frame space in the four coordinates of the display package are minimal.

For example, in a case of FIG. 18B (that is, the case where the display package belongs to the second area R2), the display area generator 165 determines a minimum X-coordinate (xmin) and a maximum Y-coordinate (ymax) of the display package as the first display coordinate P1(xp1,yp1) (see FIG. 19B). In this case, the first display coordinate P1 is the coordinate in which the value of the X-coordinate on the decoded frame space in the four coordinates of the display package is minimal while the value of the Y-coordinate is maximal. In this case, “xp1=xmin” and “yp1=ymax”.

For example, in a case of FIG. 18C (that is, the case where the display package belongs to the third area R3), the display area generator 165 determines the maximum X-coordinate (xmax) and the minimum Y-coordinate (ymin) of the display package as the first display coordinate P1(xp1,yp1) (see FIG. 19C). In this case, the first display coordinate P1 is the coordinate in which the value of the X-coordinate on the decoded frame space in the four coordinates of the display package is maximal while the value of the Y-coordinate is minimal. In this case, “xp1=xmax” and “yp1=ymin”.

For example, in a case of FIG. 18D (that is, the case where the display package belongs to the fourth area R4), the display area generator 165 determines the maximum X-coordinate (xmax) and the maximum Y-coordinate (ymax) of the display package as the first display coordinate P1(xp1,yp1) (see FIG. 19D). In this case, the first display coordinate P1 is the coordinate in which the values of the X-coordinate and the Y-coordinate on the decoded frame space in the four coordinates of the display package are maximal. In this case, “xp1=xmax” and “yp1=ymax”.

In other words, the display area generator 165 determines the first display coordinate from the four points of the zone including the vertex of the decoded frame or from the side of the decoded frame in the zones constituting the display package. That is, the first display coordinate is located on the vertex or the side of the decoded frame.

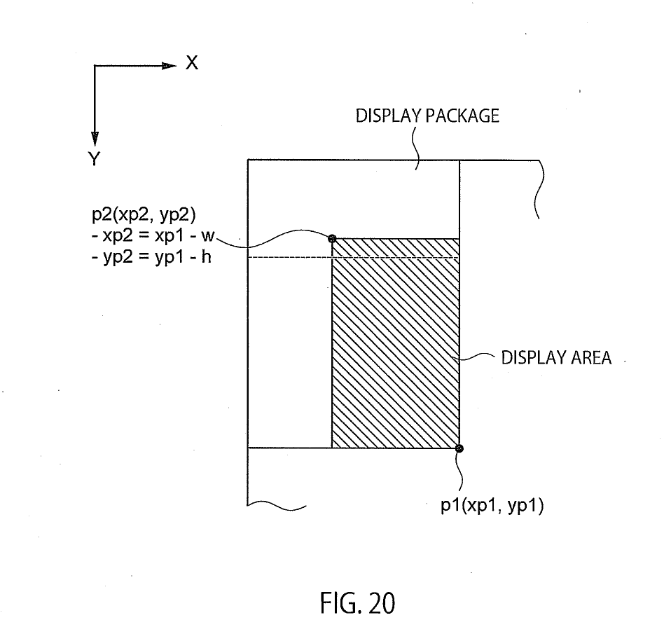

Incidentally, the display area generator 165 may determine a maximum coordinate (xmax,ymax) of the display package as the first display coordinate P1(xp1,yp1) (see FIG. 20). The maximum coordinate of the display package is the coordinate in which the values of the X-coordinate and the Y-coordinate on the decoded frame space in the four coordinates of the display package are maximal.

<S1606> The display area generator 165 determines a second display coordinate P2 based on the first display coordinate P1 and the size information.

For example, in a case of FIG. 18A, the display area generator 165 decides a sum of a display size w in an X-direction and a display size h in a Y-direction and the first display coordinate P1(xp1,yp1) as a second display coordinate P2(xp2,yp2) (see FIG. 19A). In this case, “xp2=xp1+w” and “yp2=yp1+h” are established.

For example, in a case of FIG. 18B, the display area generator 165 decides a sum of the X-coordinate (xp1) of the first display coordinate P1 and the display size w in the X-direction and a difference between the Y-coordinate (yp1) of the first display coordinate P1 and the display size h in the Y-direction as a second display coordinate P2(xp2,yp2) (see FIG. 19B). In this case, “xp2=xp1+w” and “yp2=yp1−h” are established.

For example, in a case of FIG. 18C, the display area generator 165 decides a difference between the X-coordinate (xp1) of the first display coordinate P1 and the display size w in the X-direction and a sum of the Y-coordinate (yp1) of the first display coordinate P1 and the display size h in the Y-direction as the second display coordinate P2(xp2,yp2) (see FIG. 19C). In this case, “xp2=xp1−w” and “yp2=yp1+h” are established.

For example, in a case of FIG. 18D, the display area generator 165 decides a difference between the first display coordinate P1(xp1,yp1) and the display size w in the X-direction and the display size h in the Y-direction as the second display coordinate P2(xp2,yp2) (see FIG. 19D). In this case, “xp2=xp1−w” and “yp2=yp1−h” are established.

On the other hand, when the first display coordinate P1(xp1,yp1) is determined as the maximum coordinate (xmax,ymax) of the display package, the display area generator 165 determines a difference between the first display coordinate P1(xp1,yp1) and the display size w in the X-direction and the display size h in the Y-direction as the second display coordinate P2(xp2,yp2) (see FIG. 20). In this case, “xp2=xp1−w” and “yp2=yp1−h” are established.

When S1606 ends, the display manager 18 disposes the video frame in the video layer, disposes the application image data in the display area (that is, a rectangular area specified by the first display coordinate P1 and the second display coordinate P2) of the application layer, and combines the application layer and the video layer to generate the display image (S604). Therefore, the display image including the application image, which is displayed while overlaid on an unimportant area (display area) of the video frame, is obtained as illustrated in FIG. 2.

According to the embodiment, the display area selector 16 calculates the vector activity based on the motion vector, calculates the coefficient activity based on the DCT coefficient, calculates the zone activity based on the vector activity and the coefficient activity, and selects the display area based on the zone activity to display the application image. In other words, based on the zone activity obtained from the motion vector, the display area selector 16 selects the display area such that the application image is disposed in the area having the small degree of importance in the display image. Accordingly, irrespective of the motion amount of the background image, the application image can be displayed in the display area (for example, the area having the small motion in the whole frame) according to a characteristic of the motion in the whole frame. Particularly, the vertex of the decoded frame is decided as the first display coordinate P1(xp1,yp1), which allows the display image to be displayed without dividing the display image.

At least a portion of the image processing apparatus 10 to the above-described embodiments may be composed of hardware or software. When at least a portion of the image processing apparatus 10 is composed of software, a program for executing at least some functions of the image processing apparatus 10 may be stored in a recording medium, such as a flexible disk or a CD-ROM, and a computer may read and execute the program. The recording medium is not limited to a removable recording medium, such as a magnetic disk or an optical disk, but it may be a fixed recording medium, such as a hard disk or a memory.

In addition, the program for executing at least some functions of the image processing apparatus 10 according to the above-described embodiment may be distributed through a communication line (which includes wireless communication) such as the Internet. In addition, the program may be encoded, modulated, or compressed and then distributed by wired communication or wireless communication such as the Internet. Alternatively, the program may be stored in a recording medium, and the recording medium having the program stored therein may be distributed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An image processing apparatus comprising:
a display area selector configured to select a display area in a frame of video image data based on motion of a video image in the frame and a size of an application image displayed in the display area; and
a display manager configured to combine the video image data with the application image data to generate display image data in such a manner that the application image is displayed in the display image area.

2. The apparatus of claim 1, wherein the display area selector comprises:
a vector activity calculator configured to calculate a vector activity according to a motion vector with respect to each of a plurality of zones in the frame;
a coefficient activity calculator configured to calculate a coefficient activity according to the number of discrete cosine transformation coefficients with respect to each zone;
a zone activity calculator configured to calculate a zone activity according to the vector activity and the coefficient activity with respect to each zone;
a zone selector configured to select an inactive zone in which the zone activity is minimal in all the zones; and
a display area generator configured to generate the display area in at least a part of the inactive zone.

3. The apparatus of claim 2, wherein the vector activity calculator:
calculates an accumulated motion vector in each zone, an accumulated motion amount in each zone, an average motion vector in the frame, an average motion amount in the frame;
calculates a first difference between the accumulated motion vector and the accumulated motion amount in each zone;
calculates a second difference between the accumulated motion amount and the average motion amount in the frame; and
calculates the vector activity according to the first difference and the second difference.

4. The apparatus of claim 2, wherein the coefficient activity calculator:
counts the number of discrete cosine transformation coefficients with respect to each zone;
calculates an average value of the number of discrete cosine transformation coefficients in the frame;
calculates a third difference between the number of discrete cosine transformation coefficients with respect to each zone and average value of the number of discrete cosine transformation coefficients; and
calculates the coefficient activity according to the third difference.

5. The apparatus of claim 2, wherein the display area generator decides one coordinate of four coordinates indicating four points in the inactive zone as a first display coordinate, and generates the display area in area comprising the first display coordinate.

6. The apparatus of claim 5, wherein the zone selector selects an additional inactive zone when the size of the application image is larger than a size of the selected inactive zone.

7. The apparatus of claim 6, wherein the zone selector selects a first inactive zone and a second inactive zone, the first inactive zone having a size which is smaller than the size of the application image, the second inactive zone having a minimal zone activity of zones adjacent to the first inactive zone.

8. The apparatus of claim 6, wherein the display area generator decides one coordinate of four coordinates as the first display coordinate, the four coordinates indicating four points comprising on a vertex or a side of the frame in the zones in a display package comprising a plurality of inactive zones.

9. The apparatus of claim 8, wherein the display area generator decides a second display coordinate which is a diagonal coordinate of the first display coordinate based on the first display coordinate and the size of the application image.

10. The apparatus of claim 6, wherein the display area generator decides one coordinate of four coordinates of a display package comprising a plurality of inactive zones as the first display coordinate, the decided coordinate not comprising coordinates on a vertex or a side of the frame.

11. An image displaying system comprising:
a display area selector configured to select a display area in a frame of video image data based on motion of a video image in the frame and a size of an application image displayed in the display area;
a display manager configured to combine the video image data with the application image data to generate display image data in such a manner that the application image is displayed in the display image area; and
a display configured to display the display image data.

12. The system of claim 11, wherein the display area selector comprises:
a vector activity calculator configured to calculate a vector activity according to a motion vector with respect to each of a plurality of zones in the frame;
a coefficient activity calculator configured to calculate a coefficient activity according to the number of discrete cosine transformation coefficients with respect to each zone;
a zone activity calculator configured to calculate a zone activity according to the vector activity and the coefficient activity with respect to each zone;
a zone selector configured to select an inactive zone in which the zone activity is minimal in all the zones; and
a display area generator configured to generate the display area in at least a part of the inactive zone.

13. The system of claim 12, wherein the vector activity calculator:
calculates an accumulated motion vector in each zone, an accumulated motion amount in each zone, an average motion vector in the frame, an average motion amount in the frame;
calculates a first difference between the accumulated motion vector and the accumulated motion amount in each zone;
calculates a second difference between the accumulated motion amount and the average motion amount in the frame; and
calculates the vector activity according to the first difference and the second difference.

14. The system of claim 12, wherein the coefficient activity calculator:
counts the number of discrete cosine transformation coefficients with respect to each zone;
calculates an average value of the number of discrete cosine transformation coefficients in the frame;
calculates a third difference between the number of discrete cosine transformation coefficients with respect to each zone and average value of the number of discrete cosine transformation coefficients; and
calculates the coefficient activity according to the third difference.

15. The system of claim 12, wherein the display area generator decides one coordinate of four coordinates indicating four points in the inactive zone as a first display coordinate, and generates the display area in area comprising the first display coordinate.

16. The system of claim 15, wherein the zone selector selects an additional inactive zone when the size of the application image is larger than a size of the selected inactive zone.

17. The system of claim 16, wherein the zone selector selects a first inactive zone and a second inactive zone, the first inactive zone having a size which is smaller than the size of the application image, the second inactive zone having a minimal zone activity of zones adjacent to the first inactive zone.

18. The system of claim 16, wherein the display area generator decides one coordinate of four coordinates as the first display coordinate, the four coordinates indicating four points comprising on a vertex or a side of the frame in the zones in a display package comprising a plurality of inactive zones.

19. The system of claim 18, wherein the display area generator decides a second display coordinate which is a diagonal coordinate of the first display coordinate based on the first display coordinate and the size of the application image.

20. The system of claim 16, wherein the display area generator decides one coordinate of four coordinates of a display package comprising a plurality of inactive zones as the first display coordinate, the decided coordinate not comprising coordinates on a vertex or a side of the frame.
